(19) United States
(12) Patent Application Publication
(10) Pub. No.: US 2017/0351231 A1
(43) Pub. Date: Dec. 7, 2017

(54) DEVICE, METHOD, AND SYSTEM FOR MANAGING DEVICE CONTROL

(71) Applicants: Sharp Kabushiki Kaisha, Sakai City (JP); Kabushiki Kaisha Toshiba, Tokyo (JP); NEC Corporation, Tokyo (JP); Mitsubishi Electric Corporation, Tokyo (JP)

(72) Inventors: Osamu MAESHIMA, Tokyo (JP); Haruo HINODE, Sakai City (JP); Takayuki AMATSU, Tokyo (JP); Hiroshi MASUDA, Tokyo (JP); Naoki ENDO, Tokyo (JP); Morio HIRAHARA, Yokohama (JP); Takeshi SUETSUGU, Tokyo (JP); Yoichi MASUDA, Tokyo (JP); Shoji MOCHIZUKI, Tokyo (JP)

(21) Appl. No.: 15/609,190

(22) Filed: May 31, 2017

(30) Foreign Application Priority Data
Jun. 1, 2016 (JP) 2016-110420

(51) Int. Cl. G05B 15/02; H04L 12/28

(52) U.S. Cl. CPC G05B 15/02; H04L 12/2803

(57) ABSTRACT

A first device according to one embodiment includes, but is not limited to, receiver circuitry, determinator circuitry, and transmitter circuitry. The receiver circuitry is configured and/or programmed to receive from a second device, first information for controlling a third device. The determinator circuitry is configured and/or programmed to determine whether or not the first information is to be transmitted to the third device, based on the first information received and second information stored in the first device. The second information regards at least a first parameter of the third device that the second device is authorized to control. The transmitter circuitry is configured and/or programmed to, in a case that the first information is determined to be transmitted to the third device, transmit the first information to the third device.

### BACKGROUND OF THE INVENTION

### Field of the Invention

The present invention relates to a device, method, and system for managing device control.

Priority is claimed on Japanese Patent Application No. 2016-110420, filed Jun. 1, 2016, the content of which is incorporated herein by reference.

### Description of the Related Art

According to the related art, Home Energy Management Systems (HEMSs) that perform household energy management are known. Regarding the HEMSs, to reduce energy consumption or the like, technology of controlling operation of one or more HEMS-compatible apparatuses (hereinafter referred to as “HEMS apparatuses”) in a home via an HAN (Home Area Network) is known (for example, see Japanese Patent Application Laid-Open Publication No. 2016-39564).

There are cases where operations of HEMS apparatuses are controlled based on a control method predetermined by each manufacturer or retailer of the HEMS apparatuses, or a control method predetermined by each manufacturer or retailer of devices for controlling the HEMS apparatuses.

In these cases, it has been difficult to standardize the control method since the operations of the HEMS apparatuses are controlled based on the different standard for each manufacturer or retailer of the HEMS apparatuses or the different control method predetermined by each manufacturer or retailer of the devices for controlling the HEMS apparatuses.

### SUMMARY

A first device according to one embodiment includes, but is not limited to, receiver circuitry, determinator circuitry, and transmitter circuitry. The receiver circuitry is configured and/or programmed to receive from a second device, first information for controlling a third device. The determinator circuitry is configured and/or programmed to determine whether or not the first information is to be transmitted to the third device, based on the first information received and second information stored in the first device, the second information regards at least a first parameter of the third device that the second device is authorized to control. The transmitter circuitry is configured and/or programmed to, in a case that the first information is determined to be transmitted to the third device, transmit the first information to the third device.

A method for a first device according to another embodiment includes, but is not limited to, the following processes. The first device receives from a second device, first information for controlling a third device. The first device determines whether or not the first information is to be transmitted to the third device, based on the first information received and second information stored in the first device. The second information regards at least a first parameter of the third device that the second device is authorized to control. In a case that the first information is determined to be transmitted to the third device, the first device transmits the first information to the third device.

A system according to another embodiment includes, but is not limited to, a first device, a second device to be controlled by the first device, and a third device configured to communicate with the first device and the second device. The third device includes, but is not limited to, receiver circuitry, determinator circuitry, and transmitter circuitry. The receiver circuitry is configured and/or programmed to receive from the first device, first information for controlling the second device. The determinator circuitry is configured and/or programmed to determine whether or not the first information is to be transmitted to the second device, based on the first information received and second information stored in the third device. The second information regards at least a first parameter of the second device that the first device is authorized to control. The transmitter circuitry is configured and/or programmed to, in a case that the first information is determined to be transmitted to the second device, transmit the first information to the second device.

### BRIEF DESCRIPTION OF THE DRAWINGS

The above features and advantages of the present invention will be more apparent from the following description of certain preferred embodiments taken in conjunction with the accompanying drawings.

FIG. 1 schematically illustrates a device control management system for according to a first embodiment.

FIG. 2 schematically illustrates a configuration example of a device control manager according to the first embodiment.

FIG. 3 schematically shows a table example of control information according to the first embodiment.

FIG. 4 schematically shows a table example of terminal identifiers according to the first embodiment.

FIG. 5 schematically shows a table example of application identifiers according to the first embodiment.

FIG. 6 schematically shows a table example of device identifiers according to the first embodiment.

FIG. 7 schematically shows a table example of operation reference information, setting reference information, time zone reference information, and frequency reference information according to the first embodiment.

FIG. 8 shows a flowchart showing a processing example of the device control manager according to the first embodiment.

FIG. 9 schematically illustrates a device control management system according to a modified example.

FIG. 10 schematically illustrates a device control management system according to a second embodiment.

FIG. 11 schematically shows a table example of control information according to the second embodiment.

FIG. 12 schematically illustrates a configuration example of a device control manager according to the second embodiment.

FIG. 13 shows a table example of demand reference information according to the second embodiment.

### DETAILED DESCRIPTION OF THE PREFERRED EMBODIMENTS

The present invention will now be described herein with reference to illustrative embodiments. The accompanying drawings explain a method, device, and system for managing device control in the embodiments. The size, the thickness, and the like of each illustrated portion might be different from those of each portion of an actual device.

Those skilled in the art will recognize that many alternative embodiments can be accomplished using the teachings of the present invention and that the present invention is not limited to the embodiments illustrated herein for explanatory purposes.

### First Embodiment

Hereinafter, a first embodiment of the present invention will be described with reference to the drawings.

### [Device Control Management System]

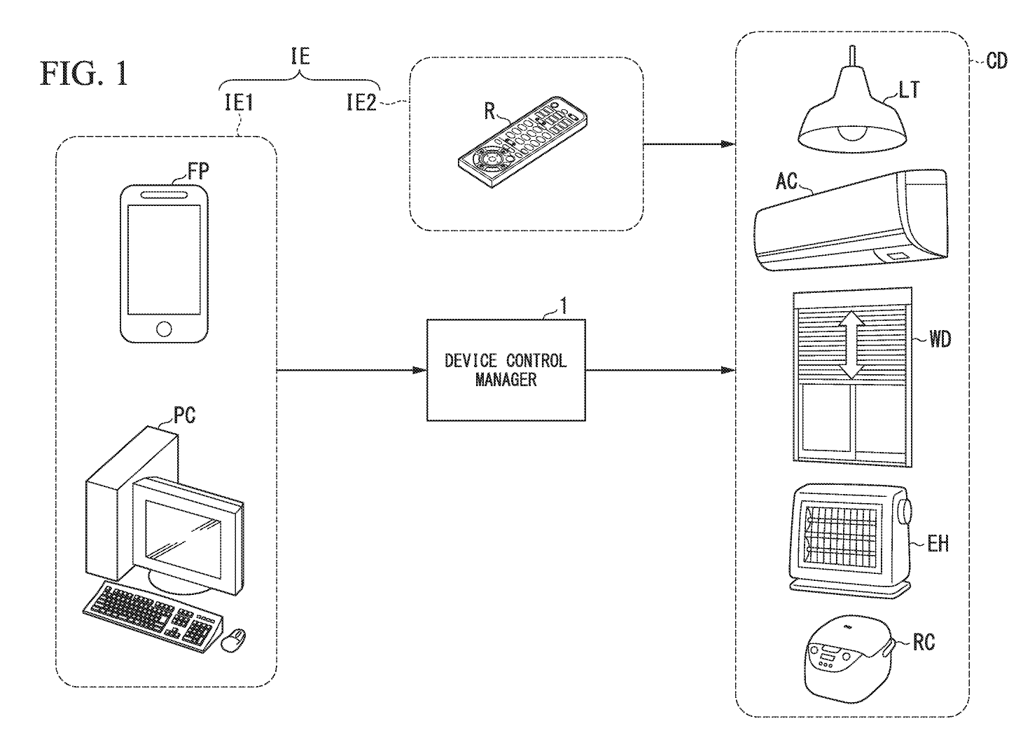

FIG. 1 schematically illustrates a device control management system according to a first embodiment.

Device controllers IE are devices that control operations of devices CD to be controlled (hereinafter referred to as “controlled devices CD”).

Examples of the controlled devices CD include electric appliances installed in a house of a general household, or the like. Specifically, the controlled devices CD include a lighting equipment LT in a living room, an air conditioner AC that adjusts the temperature and humidity of the living room, a window WD to be opened and closed according to control information from the device controllers IE, a heater EH that raises the temperature of the living room, an electric cooking appliance such as a rice cooker RC, and the like.

Hereinafter, a house of a general household installed with the controlled devices CD is simply referred to as “a house”. Additionally, a member of the household in the house is simply referred to as “an occupant.”

Examples of the device controller IE include: a remote controller R that controls operations of the controlled devices CD using infrared rays or other radio waves; and a smartphone FP and a computer PC which control operations of the controlled devices CD via a network, such as a WAN (Wide Area Network).

Hereinafter, the device controller IE configured to control operations of the controlled devices CD via a network will be referred to as “a device controller IE1,” while the device controller IE configured to control operations of the controlled devices CD without a network will be referred to as “a device controller IE2.”

Examples of the devices CD to be controlled according to control information transmitted from the device controller IE1 include an HA (Home Automation) device. The device controller IE1 can remote control the controlled devices CD by transmitting control information via the network.

### [Operational Error of Device Controller]

In a case of controlling operation of the controlled device CD from the outdoors, an operator of the device controller IE1 has difficulty in confirming the state of the controlled device CD operating according to control information transmitted from the device controller IE1. In such a case, it is difficult for the operator of the device controller IE1 to notice an operational error such that the operator has sent the control information to a wrong device CD intended not to be controlled, or the operator has sent wrong control information to the device CD intended to be controlled.

Thus, it is difficult for the operator of the device controller IE1 to get aware of such operational errors.

### [Operational Error of Malicious Device Controller]

In a case of controlling operation of the controlled device CD via the network, there is a risk that the operation of the controlled device CD might be controlled by an unauthorized operator or a malicious program, such as when the window WD as the controlled device CD is opened or closed by an unauthorized operator or a malicious program. In such a case, the window WD is opened or closed against the occupant's intent, thus threatening the safety of the house.

There is another risk that the temperature setting of the air conditioner AC as the controlled device CD might be controlled by an unauthorized operator or a malicious program. In such a case, the air conditioner AC operates according to the malicious program or control information sent from the unauthorized operator, the temperature of a room installed with the air conditioner AC is raised or lowered, thereby making it likely to impair the health of the occupant.

The device controller IE1 of the present embodiment controls operation of the controlled device CD via a device control manager 1. The device control manager 1 determines whether or not control information for controlling the controlled device CD received from the device controller IE1 is proper. If the control information received from the device controller IE1 is determined to be proper, the device control manager 1 transmits the control information to the controlled device CD.

### [Configuration of Device Control Manager]

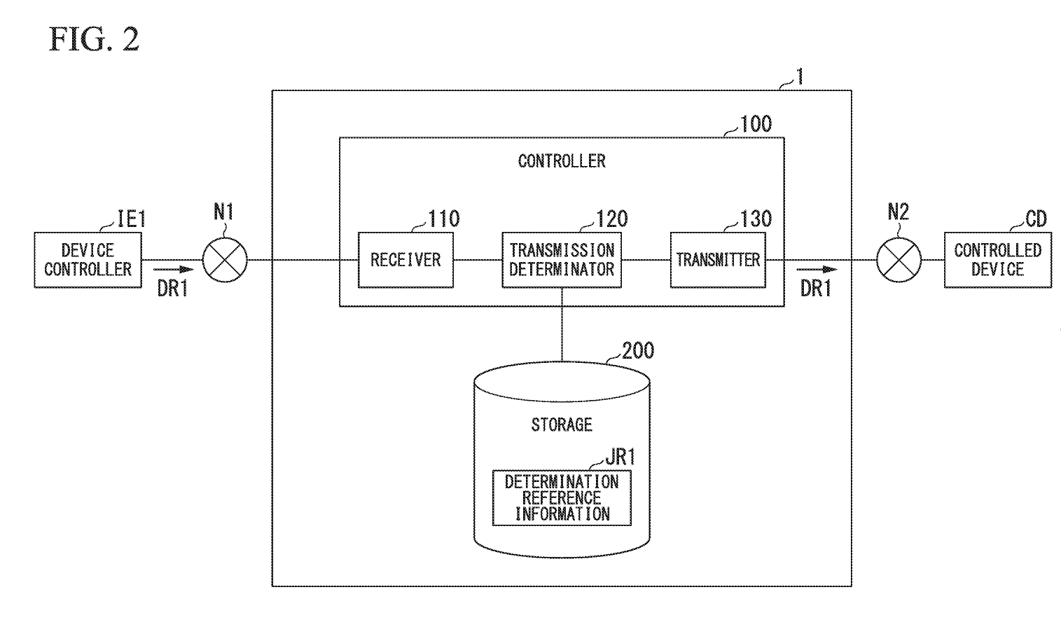

Hereinafter, a configuration of the device control manager 1 of the present embodiment will be described with reference to FIG. 2. FIG. 2 schematically illustrates a configuration example of the device control manager 1 according to the first embodiment.

As shown in FIG. 2, the device control manager 1 and the device controller IE1 are connected via a network N1, such as a WAN. Additionally, the device control manager 1 and the controlled device CD are connected via a network N2, such as a LAN (Local Area Network).

The device controller IE1 transmits control information DR1 to the device control manager 1 via the network N1. The control information DR1 is information for controlling operation of the controlled device CD.

### [Control Information]

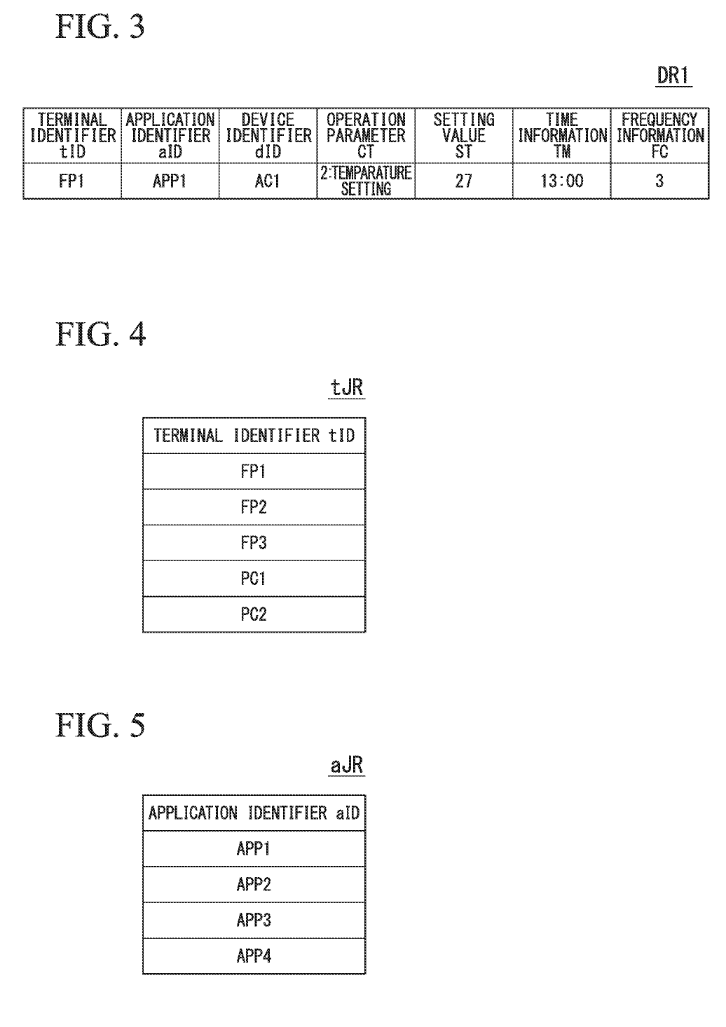

Hereinafter, the details of the control information DR1 of the present embodiment will be described with reference to FIG. 3. FIG. 3 schematically shows a table example of control information according to the first embodiment.

The control information DR1 includes a terminal identifier tID, an application identifier aID, a device identifier dID, an operation parameter CT, a setting value ST, time information TM, and frequency information FC. The terminal identifier tID is information to identify the device controller IE1 that transmits the control information DR1. The terminal identifier tID is the serial number of the smartphone FP or the computer PC as the device controller IE1. The application identifier aID is information to identify an application and software, or the like, to be used for the device controller IE1 to transmit the control information DR1.

The device identifier dID is information to identify the device CD to be controlled by the device controller IE1. Examples of the device identifier dID include the serial number of the controlled device CD. The operation parameter CT is an operation parameter of the controlled device CD to be controlled by the device controller IE1.

The setting value ST is a value to be set to the operation parameter of the device CD to be controlled by the device controller IE1.

The time information TM is information indicating the time at which the device controller IE1 is to transmit the control information DR1.

The frequency information FC is information indicating the frequency per unit time at which the device controller IE1 is to transmit the control information DR1. For example, the device controller IE1 includes a buffer that records the number of times the control information DR1 has been transmitted for a past period preset. For example, the frequency information FC may be information indicating the number of times the device controller IE1 has transmitted the control information DR1 for the past one minute.

The control information DR1 shown in the example of FIG. 3 indicates that the smartphone identified by the terminal identifier “FP1” is to transmit the control information DR1 at the time “13:00”, at the frequency “3 times a minute”, using the application identified by the application identifier “APP1”, to the air conditioner AC identified by the device identifier “AC1” which is to be controlled to set a value “27” to the operation parameter “2: temperature setting”.

Although the description has been given above with respect to the case where the control information DR1 includes the terminal identifier tID, the application identifier aID, the device identifier dID, the operation parameter CT, the setting value ST, the time information TM, and the frequency information FC, the present embodiment is not limited thereto. For example, the control information DR1 may include at least one of these information items.

Although the description has been given above with respect to the case where the time information TM is information indicating the time at which the device controller IE1 is to transmit the control information DR1, the present embodiment is not limited thereto. For example, the time information TM may be information indicating the time at which the device control manager 1 is to receive the control information DR1 from the device controller IE1.

### [Determination Reference Information]

Returning to FIG. 2, the device control manager 1 includes a controller 100 and a storage 200.

The storage 200 previously stores determination reference information JR1. The determination reference information JR1 is reference information to be used for determining whether or not the control information DR1 received from the device controller IE1 is proper to be transmitted to the controlled device CD. Specifically, the determination reference information JR1 includes terminal reference information tJR, application reference information aJR, device reference information dJR, operation reference information CJR, setting reference information SJR, time zone reference information PJR, and frequency reference information FJR.

The terminal reference information tJR is information indicating the terminal identifier tID of the device controller IE1 authorized to control the operations of the controlled devices CD. Examples of the terminal identifier tID included in the terminal reference information tJR include the terminal identifier tID of the smartphone FP or the computer PC of a family member who is an occupant of the house.

The application reference information aJR is information indicating the application identifier aID of the application and software authorized to be used for controlling the operations of the controlled devices CD. Specifically, the application and software identified by the application identifier aID included in the application reference information aJR meet the device control standard used in controlling the operations of the controlled devices CD. Examples of the device control standard include the safety standard provided by a certificate authority that evaluates the safety of applications and softwares.

The device reference information dJR is information indicating the device identifier dID of the device CD to be controlled by the control information DR1 received from the device controller IE1 via the device control manager 1. Specifically, the device identifier dID included in the device reference information dJR is the device identifier dID of the controlled device CD installed in a house.

The operation reference information CJR is information indicating authorized operation parameters CT of the device CD to be controlled by the device controller IE1.

The setting reference information SJR is information indicating authorized setting values of the authorized operation parameters CT included in the operation reference information CJR.

The time zone reference information PJR is information indicating a time zone within which the operation of the controlled device CD is authorized to be controlled by the control information DR1.

The frequency reference information FJR is information indicating the number of times per unit time the control information DR1 is to be transmitted from the device controller IE1 to the device control manager 1.

Hereinafter, the details of the determination reference information JR1 will be described with reference to FIGS. 4 to 7.

FIG. 4 schematically shows a table example of the terminal reference information tJR of the first embodiment. This table indicates that “FP1, FP2, FP3” are the terminal identifiers tID of the smartphones FP authorized to control the controlled devices CD. This table also indicates that “PC1, PC2” are the terminal identifiers tID of the computers PC authorized to control the controlled devices CD. Thus, the terminal reference information tJR indicates the terminal identifiers tID “FP1, FP2, FP3, PC1, PC2” of the device controllers IE1 authorized to control the controlled devices CD. FIG. 5 schematically shows a table example of the application reference information aJR of the first embodiment. This table indicates that “APP1, APP2, APP3, APP4” are the application identifiers aID of the application and software sets authorized to be used for controlling the operations of the controlled devices CD.

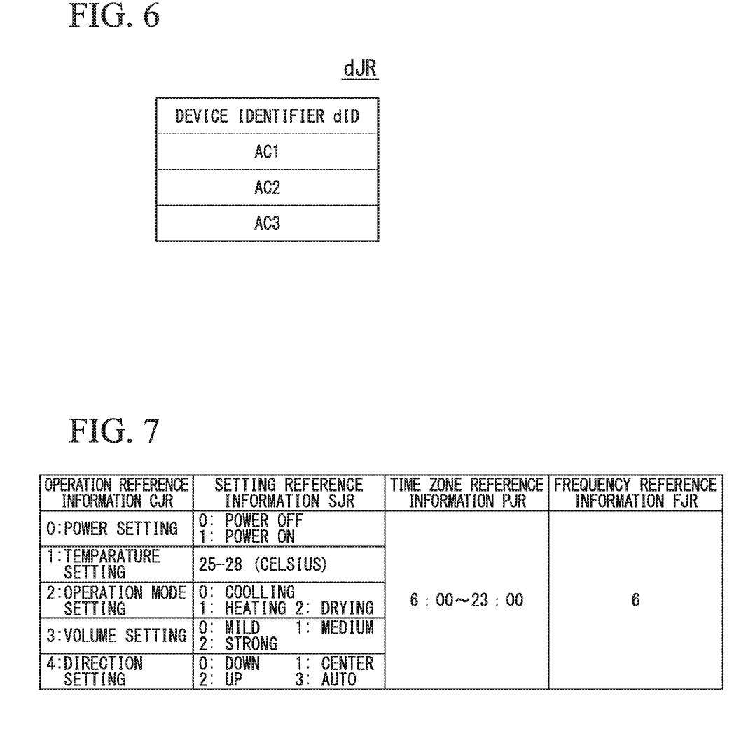

FIG. 6 schematically shows a table example of the device reference information dJR of the first embodiment. This table indicates that “AC1, AC2, AC3” are the device identifiers dID of the devices CD to be controlled by the control information DR1 received from the device controller IE1 via the device control manager 1.

FIG. 7 schematically shows a table example of the operation reference information CJR, the setting reference information SJR, the time zone reference information PJR, and the frequency reference information FJR of the first embodiment.

In this example, the operation reference information CJR includes operation parameters CT which are “0: power setting”, “1: temperature setting”, “2: operation mode setting”, “3: air volume setting”, and “4: air direction setting”.

Additionally, the setting reference information SJR associated with “0: power supply setting” as the operation parameter CT included in the operation reference information CJR includes the setting values ST which are “0: power supply OFF” and “1: power supply ON”.

Further, the setting reference information SJR associated with “1: temperature setting” as the operation parameter CT included in the operation reference information CJR includes the setting value ST which is “25 to 28 (Celsius)”. In other words, “25 to 28 (Celsius)” as the setting value ST is the range of temperature of the air conditioner AC controllable by the device controller IE1.

Moreover, the setting reference information SJR associated with “2: operation mode setting” as the operation parameter CT included in the operation reference information CJR includes the setting values ST which are “0: cooling”, “1: heating”, and “2: drying”.

Additionally, the setting reference information SJR associated with “3: air volume setting” as the operation parameter CT included in the operation reference information CJR includes the setting values ST which are “0: mild”, “1: medium”, and “2: strong”.

Further, the setting reference information SJR associated with “4: air direction setting” as the operation parameter CT set included in the operation reference information CJR includes the setting values ST which are “0: down”, “1: center”, “2: up”, and “3: auto”.

Moreover, “6:00 to 23:00” as the time zone reference information PJR is the time zone within which the operation of the controlled device CD is authorized to be controlled by the control information DR1. In other words, the time zone reference information PJR indicates that only within the time zone from 6:00 to 23:00, the device controller IE1 is authorized to control the operation of the controlled device CD.

As shown in FIG. 7, the operation parameters CT included in the operation reference information CJR are authorized to be controlled only within the time zone indicated by the time zone reference information PJR.

Additionally, the frequency reference information FJR indicates that the maximum allowable number of times per minute the device controller IE1 is authorized to transmit the control information DR1 is “6”.

As shown in FIG. 7, the operation parameters CT included in the operation reference information CJR are authorized to be controlled only if the number of times per minute the device controller IE1 has transmitted the control information DR1 is equal to or less than the value indicated by the frequency reference information FJR.

Although the description has been given above with respect to the case where the determination reference information JR1 includes the terminal reference information tJR, the application reference information aJR, the device reference information dJR, the operation reference information CJR, the setting reference information SJR, the time zone reference information PJR, and the frequency reference information FJR, the present embodiment is not limited thereto. For example, the determination reference information JR1 may include at least one of the above reference information items included in the control information DR1 received from the device controller IE1.

Returning to FIG. 2, the controller 100 includes a CPU (Central Processing Unit), and, as its functional elements, a receiver 110, a transmission determinator 120, and a transmitter 130.

The receiver 110 receives the control information DR1 from the device controller IE1 via the network N1. The receiver 110 gives the received control information DR1 to the transmission determinator 120.

The transmission determinator 120 receives the control information DR1 from the receiver 110. Further, the transmission determinator 120 retrieves the determination reference information JR1 from the storage 200.

If each information item included in the control information DR1 meets the standard indicated by the determination reference information JR1, the transmission determinator 120 determines that the control information DR1 is proper to be transmitted to the controlled device CD. If the control information DR1 is determined to be proper to be transmitted, the transmission determinator 120 gives the control information DR1 to the transmitter 130. Meanwhile, if the control information DR1 is determined not to be proper to be transmitted, the transmission determinator 120 does not give the control information DR1 to the transmitter 130.

The transmitter 130 receives the control information DR1 from the transmission determinator 120. The transmitter 130 transmits the received control information DR1 to the controlled device CD via the network N2. The controlled device CD operates according to the control information DR1 transmitted from the device control manager 1.

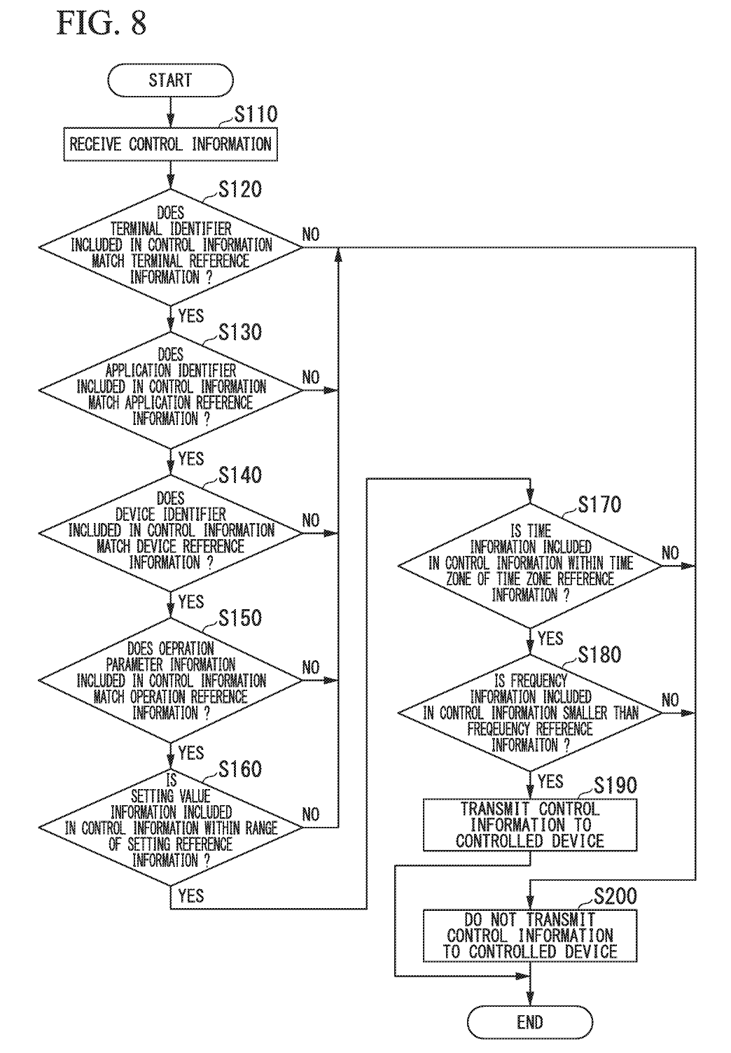

Hereinafter, processing of the device control manager 1 will be described with reference to FIG. 8. FIG. 8 shows a flowchart showing a processing example of the device control manager 1 of the first embodiment.

The receiver 110 receives the control information DR1 from the device controller IE1 (step S110).

The transmission determinator 120 determines whether or not the terminal identifier tID included in the control information DR1 received from the receiver 110 matches any one of the terminal identifiers tID included in the terminal reference information tJR (step S120). If the terminal identifier tID is determined not to match any one of the terminal identifiers tID included in the terminal reference information tJR (step S120; NO), the transmission determinator 120 proceeds to step S200. If the terminal identifier tID is determined to match any one of the terminal identifiers tID included in the terminal reference information tJR (step S120; YES), the transmission determinator 120 proceeds to step S130.

Additionally, the transmission determinator 120 determines whether or not the application identifier aID included in the control information DR1 matches any one of the application identifiers aID included in the application reference information aJR (step S130). If the application identifier aID is determined not to match any one of the application identifiers aID included in the application reference information aJR (step S130; NO), the transmission determinator 120 proceeds to step S200. If the application identifier aID is determined to match any one of the application identifiers aID included in the application reference information aJR (step S130; YES), the transmission determinator 120 proceeds to step S140.

Further, the transmission determinator 120 determines whether or not the device identifier dID included in the control information DR1 matches any one of the device identifiers dID included in the device reference information dJR (step S140). If the device identifier dID is determined not to match any one of the device identifiers dID included in the device reference information dJR (step S140; NO), the transmission determinator 120 proceeds to step S200. If the device identifier dID is determined to match any one of the device identifiers dID included in the device reference information dJR (step S140; YES), the transmission determinator 120 proceeds to step S150.

Moreover, the transmission determinator 120 determines whether or not the operation parameter CT included in the control information DR1 matches any one of the operation parameters CT included in the operation reference information CJR (step S150). If the operation parameter CT is determined not to match any one of the operation parameters CT included in the operation reference information CJR (step S150; NO), the transmission determinator 120 proceeds to step S200. If the operation parameter CT is determined to match any one of the operation parameters CT included in the operation reference information CJR (step S150; YES), the transmission determinator 120 proceeds to step S160.

Additionally, the transmission determinator 120 determines whether or not the setting value ST included in the control information DR1 is within the range of the setting value ST indicated by the setting reference information SJR (step S160). If the setting value ST is determined not to be within the range of the setting value ST indicated by the setting reference information SJR (step S160; NO), the transmission determinator 120 proceeds to step S200. If the setting value ST is determined to be within the range of the setting value ST indicated by the setting reference information SJR (step S160; YES), the transmission determinator 120 proceeds to step S170.

Further, the transmission determinator 120 determines whether or not the time information TM included in the control information DR1 is within the time zone indicated by the time zone reference information PJR (step S170). If the time information TM is determined not to be within the time zone indicated by the time zone reference information PJR (step S170; NO), the transmission determinator 120 proceeds to step S200. If the time information TM is determined to be within the time zone indicated by the time zone reference information PJR (step S170; YES), the transmission determinator 120 proceeds to step S180.

Moreover, the transmission determinator 120 determines whether or not the frequency information FC included in the control information DR1 is smaller than the frequency information FC indicated by the frequency reference information FJR (step S180). If the frequency information FC is determined to be equal to or larger than the frequency information FC indicated by the frequency reference information FJR (step S180; NO), the transmission determinator 120 does not give the control information DR1 to the transmitter 130. In other words, the device control manager 1 does not transmit the control information DR1 to the controlled device CD (step S200). If the transmission determinator 120 determines that the frequency information FC is smaller than the frequency information FC indicated by the frequency reference information FJR (step S180; YES), the transmitter 130 transmits to the controlled device CD, the control information DR1 received from the transmission determinator 120. In other words, the device control manager 1 transmits the control information DR1 to the controlled device CD (step S190).

### Summary of First Embodiment

As described above, the device control manager 1 according to one example of the first embodiment includes the receiver 110, the transmission determinator 120, and the transmitter 130.

The receiver 110 receives from the device controller IE1, the control information DR1 for controlling the operation of the controlled device CD.

The transmission determinator 120 receives control information DR1 from the receiver 110 and determines whether or not the control information DR1 is to be transmitted to the controlled device CD, based on the determination reference information JR1 to be used for determining whether or not the control information DR1 is proper to be transmitted.

If the transmission determinator 120 determines that the control information DR1 is to be transmitted, the transmitter 130 transmits the control information DR1 to the controlled device CD.

According to the related art, there are cases where operations of devices to be controlled by a device controller are controlled based on the different device control standard for each manufacturer or retailer of the controlled devices or the different control method predetermined by each manufacturer or retailer of the device controller. In these cases, it has been difficult to standardize the control method.

The device control manager 1 of the present embodiment receives from the device controller IE1, the control information DR1 for controlling the controlled device CD. Then, the device control manager 1 determines based on the determination reference information JR1 whether or not to transmit the control information DR1 to the controlled device CD. For this reason, even in a case where each manufacturer or retailer of the controlled devices and each manufacturer or retailer of the device controller differ from one another, the device control standard for the control information DR1 to be transmitted is predetermined as the determination reference information JR1, thereby making it possible to control the operations of the controlled devices CD, regardless of the type of controlled device CD.

Therefore, according to the device control manager 1 of the present embodiment, it is possible to standardize the method of controlling the operations of the controlled devices CD via the device control manager 1.

Additionally, in the device control manager 1 of the first embodiment, the determination reference information JR1 includes at least one of: the frequency reference information FJR indicating the frequency at which the control information DR1 is to be transmitted from the device controller IE1; the setting reference information SJR indicating an operational range of the operation parameters CT of the controlled device CD indicated by the control information DR1; and the time zone reference information PJR indicating a time zone within which the control information DR1 is to be received from the device controller IE1. Based on at least one of the frequency reference information FJR, the setting reference information SJR, and the time zone information PJR, the transmission determinator 130 determines whether or not the control information DR1 is to be transmitted to the controlled device CD.

For example, in a case where operation of the controlled device CD is controlled by a malicious operator, control information is likely to be transmitted at high frequency in a short time period.

The device control manager 1 of the present embodiment determines based on the frequency reference information FJR whether or not to transmit the control information DR1 to the controlled device CD. If the frequency information FC included in the control information DR1 is smaller in value than the frequency information FC indicated by the frequency reference information FJR, the device control manager 1 transmits the control information DR1 to the controlled device CD. If the frequency information FC included in the control information DR1 is equal to or larger in value than the frequency information FC indicated by the frequency reference information FJR, the device control manager 1 does not transmit the control information DR1 to the controlled device CD.

According to the device control manager 1 of the present embodiment, in a case where the frequency information FC included in the control information DR1 is improper because the frequency information FC included in the control information DR1 is equal to or larger in value than the frequency reference information FJR, it is possible to prevent the improper control information from being transmitted.

Therefore, the device control manager 1 of the present embodiment can prevent the operation of the controlled device CD from being controlled by the improper control information DR1.

For example, there are cases where the setting reference information SJR differs for each of air conditioners AC installed in respective rooms of the house. For example, the temperature range of the air conditioner AC installed in a living room used by an elderly person is likely to be set stricter than the temperature range of the air conditioner AC installed in the other living rooms.

The device control manager 1 according to the present embodiment determines based on the setting reference information SJR whether or not to transmit the control information DR1 to the controlled device CD. If the setting value ST included in the control information DR1 is within the range of the setting value ST indicated by the setting reference information SJR, the device control manager 1 transmits the control information DR1 to the controlled device CD. If the setting value ST included in the control information DR1 is not within the range of the setting value ST indicated by the setting reference information SJR, the device control manager 1 does not transmit the control information DR1 to the controlled device CD.

According to the device control manager 1 of the present embodiment, in a case where the control information DR1 is improper to be transmitted because the setting value ST included in the control information DR1 is not within the range of the setting value ST indicated by the setting reference information SJR, it is possible to prevent the operation of the controlled device CD from being controlled by the improper control information DR1.

Therefore, the device control manager 1 of the present embodiment can prevent improper control information from being transmitted to the controlled device CD.

For example, in a case where operation of the controlled device CD is controlled by a malicious operator, control information is likely to be transmitted in the midnight time zone.

The device control manager 1 according to the present embodiment determines based on the time zone reference information PJR whether or not to transmit the control information DR1 to the controlled device CD. If the time information TM included in the control information DR1 is within the time zone PT indicated by the time zone reference information PJR, the device control manager 1 transmits the control information DR1 to the controlled device CD. If the time information TM included in the control information DR1 is not within the time zone PT indicated by the time zone reference information PJR, the device control manager 1 does not transmit the control information DR1 to the controlled device CD.

According to the device control manager 1 of the present embodiment, in a case where the control information DR1 is improper to be transmitted because the time information TM included in the control information DR1 is not within the time zone PT indicated by the time zone reference information PJR, it is possible to prevent improper control information DR1 from being transmitted.

Therefore, the device control manager 1 of the present embodiment can prevent the operation of the controlled device CD from being controlled by the improper control information DR1.

Additionally, the device control manager 1 of the present embodiment determines based on the terminal reference information tJR whether or not to transmit the control information DR1 to the controlled device CD. If the terminal identifier tID included in the control information DR1 is included in the terminal reference information tJR, the device control manager 1 transmits the control information DR1 to the controlled device CD. If the terminal identifier tID included in the control information DR1 is not included in the terminal reference information tJR, the device control manager 1 does not transmit the control information DR1 to the controlled device CD.

If the terminal identifier tID included in the control information DR1 is not one of the terminal identifiers of the family smartphone FP, the computer PC, and the like, which have been pre-registered, the device control manager 1 does not transmit the control information DR1.

According to the device control manager 1 of the present embodiment, in a case where the control information DR1 is improper to be transmitted because the terminal identifier tID included in the control information DR1 is not included in the terminal reference information tJR, it is possible to prevent the improper control information DR1 from being transmitted.

Therefore, the device control manager 1 of the present embodiment can prevent the operation of the controlled device CD from being controlled by the improper control information DR1.

Further, the device control manager 1 of the present embodiment determines based on the application reference information aJR whether or not to transmit the control information DR1 to the controlled device CD. If the application identifier aID included in the control information DR1 is included in the application reference information aJR, the device control manager 1 transmits the control information DR1 to the controlled device CD. If the application identifier aID included in the control information DR1 is not included in the application reference information aJR, the device control manager 1 does not transmit the control information DR1 to the controlled device CD.

Here, the application identifier aID included in the application reference information aJR is the application identifier aID of the application that meets the device control standard used in controlling the operations of the controlled devices CD.

According to the device control manager 1 of the present embodiment, in a case where the control information DR1 is improper to be transmitted because the application identifier aID included in the control information DR1 is not included in the application reference information aJR, it is possible to prevent the improper control information DR1 from being transmitted.

Therefore, the device control manager 1 of the present embodiment can prevent the operation of the controlled device CD from being controlled by the improper control information DR1.

Moreover, the device control manager 1 of the present embodiment determines based on the device reference information dJR whether or not to transmit the control information DR1 to the controlled device CD. If the device identifier dID included in the control information DR1 is included in the device reference information dJR, the device control manager 1 transmits the control information DR1 to the controlled device CD. If the device identifier dID included in the control information DR1 is not included in the device reference information dJR, the device control manager 1 does not transmit the control information DR1 to the controlled device CD.

According to the device control manager 1 of the present embodiment, in a case where the control information DR1 is improper to be transmitted because the device identifier dID included in control information DR1 is not included in the device reference information dJR, it is possible to prevent the improper control information DR1 from being transmitted.

Therefore, the device control manager 1 of the present embodiment can prevent the operation of the controlled device CD from being controlled by the improper control information DR1.

Additionally, the device control manager 1 of the present embodiment determines based on the operation reference information CJR whether or not to transmit the control information DR1 to the controlled device CD. If the operation parameter CT included in the control information DR1 is included in the operation reference information CJR, the device control manager 1 transmits the control information DR1 to the controlled device CD. If the operation parameter CT included in the control information DR1 is not included in the operation reference information CJR, the device control manager 1 does not transmit the control information DR1 to the controlled device CD.

According to the device control manager 1 of the present embodiment, in a case where the control information DR1 is improper to be transmitted because the operation parameter CT included in control information DR1 is not included in the operation reference information CJR, it is possible to prevent the improper control information DR1 from being transmitted.

Therefore, the device control manager 1 of the present embodiment can prevent the operation of the controlled device CD from being controlled by the improper control information DR1.

Here, the controlled devices CD, which are devices to be controlled by the device control manager 1, refer to electric appliances. For example, in a case where the controlled device CD is a device used in an office and is controlled via a network, network communication with the controlled device CD is generally protected by an administrator of the office network.

On the other hand, in a case where the controlled device CD is an electric appliance used in the home and is controlled via a network, unlike in the case of the controlled device CD used in the office, network communication with the controlled device CD might not be adequately protected because a network administrator is not provided at home.

Even in such a case, however, according to the device control manager 1 of the present embodiment, the operation of the controlled device CD is controlled by the device controller IE1 via the device control manager 1, thereby preventing the operation of the controlled device CD from being controlled by improper control information DR1.

Therefore, even in a case where a network administrator is not provided at home, the device control manager 1 of the present embodiment can prevent operation of the home electric appliance from being controlled by improper control information DR1, thereby enhancing the safety of the house.

Although the description has been given above with respect to the case where the controlled device CD is used in home where a network administrator is not provided, the prevent embodiment is not limited thereto. The controlled devices CD may be devices installed in other environments not provided with network administrators.

For example, the controlled devices CD may be office devices used in an office not provided with a network administrator, such as a printer, a copier, an air conditioner, a lighting equipment, a window, a blind, and a projector.

Here, in a case where an office is not provided with network administrators because a small number of people work in the office, network communication might not be adequately protected.

Even in such a case, however, according to the device control manager 1 of the present embodiment, operation of the controlled device CD is controlled by the device controller IE1 via the device control manager 1, thereby preventing the operation of the controlled device CD from being controlled by improper control information DR1.

Therefore, the device control manager 1 of the present embodiment can prevent the operation of the office equipment used in the office not provided with network administrators from being controlled by improper control information DR1.

### Modified Example

The description has been given in the first embodiment with respect to the case where the device control manager 1 transmits the control information DR1 to the controlled device CD if the device control manager 1 determines that the control information DR1 received from the device controller IE1 is proper to be transmitted to the controlled device CD.

A modified example described hereinafter differs from the first embodiment in that if the device control manager 1 determines to transmit to the controlled device CD, the control information DR1 received from the first device controller IE1, the device control manager 1 transmits the control information DR1 to a second device controller 20 different from the first device controller IE1 having transmitted the control information DR1.

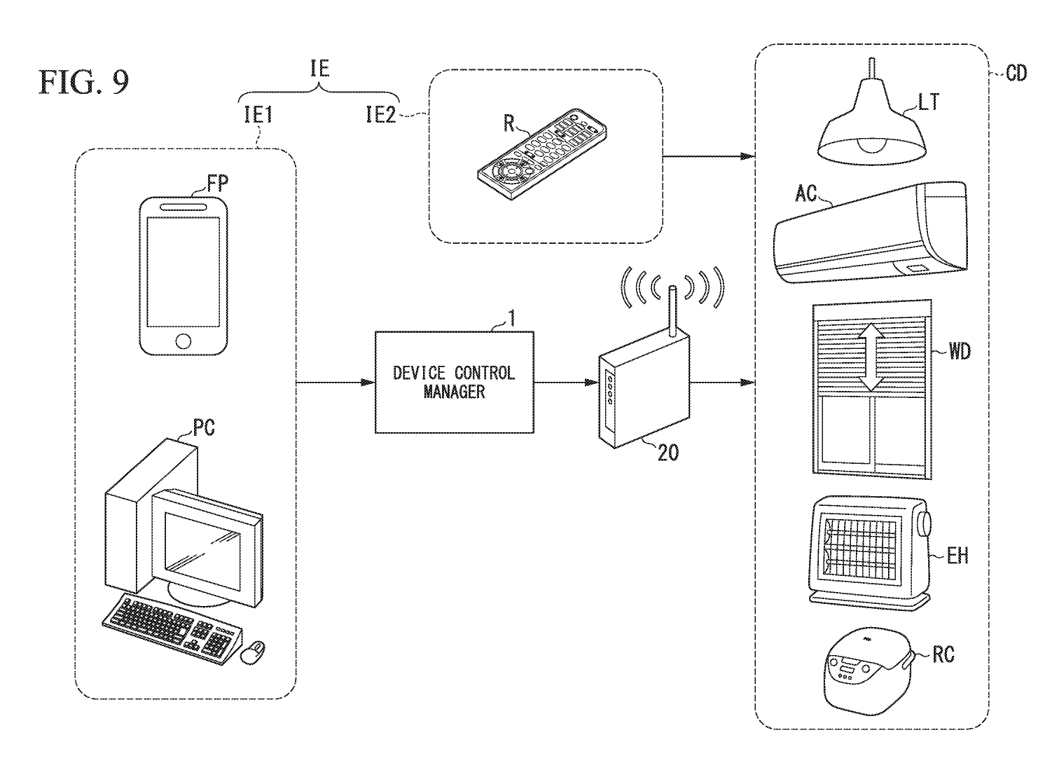

Hereinafter, the modified example will be described below with reference to FIG. 9. Here, like reference numerals refer to like elements between the first embodiment and the modified example, and description thereof is omitted.

### [Device Control Management System]

FIG. 9 schematically illustrates a device control management system according to the modified example.

As described above, if the device control manager 1 determines to transmit to the controlled device CD, control information DR1 received from the first device controller IE1, the device control manager 1 transmits the control information DR1 to the second device controller 20 different from the first device controller IE1.

Examples of the second device controller 20 include an HEMS controller. The second device controller 20 transmits to the controlled device CD, the control information DR1 received from the device control manager 1.

Here, the second device controller 20 may perform an operation other than transmitting the control information DR1 to the controlled device CD. For example, the second device controller 20 may acquire information regarding transmission history of the control information DR1 transmitted to the controlled device CD in the past. Further, the second device controller 20 may transmit to a server or the like of the manufacturer or retailer of the controlled device CD, the control information DR1 transmitted to the controlled device CD.

According to the device control system of the modified example, the device control manager 1 transmits to the second device controller 20, the control information DR1 determined by the device control manager 1 to be transmitted to the controlled device CD.

Additionally, the second device controller 20 can perform an operation according to the controlled device CD, which is other than transmitting the control information DR1 to the controlled device CD.

The device control manager 1 can transmit the control information DR1 to the controlled device CD via the second device controller 20, regardless of the type of controlled device CD. This enables the device control manager 1 to omit an additional control process specific to each controlled device CD used in home.

Although the description has been given in the modified example with respect to the case where the device control manager 1 determines whether or not to transmit the control information DR1 to the controlled device CD, the present embodiment is not limited thereto. For example, the processing of determining whether or not to transmit the control information DR1 to the controlled device CD may be divided between the device control manager 1 and the second device controller 20, so that each device performs allocated processes divided from the processing.

For example, the device control manager 1 determines whether or not the terminal identifier tID and the application identifier aID, which are included in the control information DR1, are included respectively in the terminal reference information tJR and the application reference information aJR. If the terminal identifier tID and the application identifier aID are included respectively in the terminal reference information tJR and the application reference information aJR, the device control manager 1 transmits the control information DR1 to the second device controller 20.

On the other hand, the second device controller 20 determines whether or not the device identifier dID, the operation parameter CT, the setting value ST, the time information TM, and the frequency information FC, which are included in the control information DR1 received from the device control manager 1, are included respectively in the device reference information dJR, the operation reference information CJR, the setting reference information SJR, the time zone reference information PJR, and the frequency reference information FJR. The second device controller 20 transmits the control information DR1 to the controlled device CD if the device identifier dID, the operation parameter CT, the setting value ST, the time information TM, and the frequency information FC are included respectively in the device reference information dJR, the operation reference information CJR, the setting reference information SJR, the time zone reference information PJR, and the frequency reference information FJR.

Here, in a case where the device control manager 1 is provided outside the house, while the second device controller 20 is provided inside the house, the terminal identifier tID and the application identifier aID, which are included in the control information DR1, are subject to the determination by the device control manager 1 provided outside the house, while the device identifier dID, the operation parameter CT, the setting value ST, the time information TM, and the frequency information FC, which are included in the control information DR1, are subject to the determination by the second device controller 20 provided inside the house.

Therefore, the determination reference information JR1 is divided between the device control manager 1 and the second device controller 20 so that each device stores allocated information items of the determination reference information JR1.

For example, in the case where the device control manager 1 is provided outside the house, while the second device controller 20 is provided inside the house, some items of the determination reference information JR1 are stored in the second device controller 20 provided inside the house, thereby reducing a likelihood that the setting information included in the determination reference information JR1 will be leaked to the outside.

As a result, the device control manager 1 and the second device controller 20 of the modified example can reduce the risk that personal information regarding the environments in the house indicated by the determination reference information JR1 might be leaked to persons other than the occupants.

Although the description has been given in the modified example with respect to the case where the device control manager 1 checks the terminal identifier tID and the application identifier aID which are included in the control information DR1, while the second device controller 20 checks the device identifier dID and the operation parameter CT, the setting value ST, the time information TM, and the frequency information FC, the present embodiment is not limited thereto.

For example, the device control manager 1 of the modified example may check at least one of the terminal identifier tID, the application identifier aID, the device identifier dID, the operation parameter CT, the setting value ST, and the time information TM, which are included in the control information DR1, while the second device controller 20 may check the information items other than those checked by the device control manager 1.

### Second Embodiment

Although the description has been given in the first embodiment and the modified example with respect to the case where the device control manager 1 receives the control information DR from the device controller IE1, the present embodiment is not limited thereto.

A second embodiment described hereinafter differs from the first embodiment and the modified example in that the device control manager 1 receives control information DR from an electricity utility other than the device controller IE1.

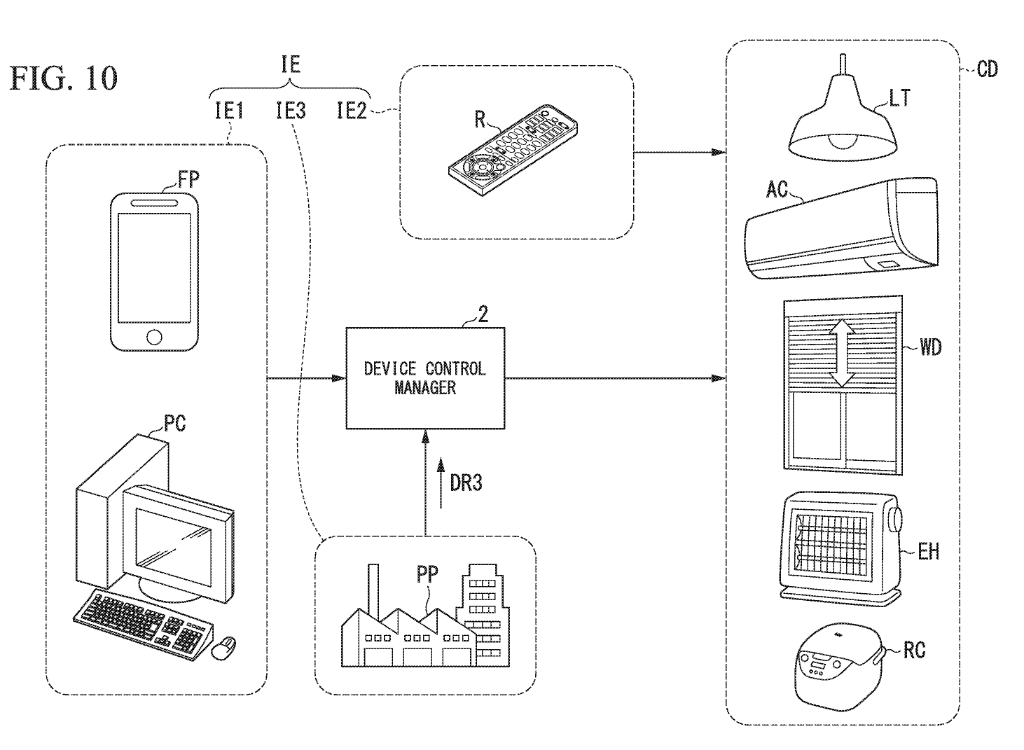

Hereinafter, a device control manager 2 of the second embodiment will be described with reference to FIG. 10. Here, like reference numerals refer to like elements among the first embodiment, the modified example, and the second embodiment, and description thereof is omitted.

### [Device Control Management System]

FIG. 10 schematically illustrates a device control management system according to a second embodiment.

A device controller IE3 transmits control information DR3 to the device control manager 2. The device controller IE3 is a device of the electricity utility and transmits the control information DR3 to the device control manager 2. Examples of the electricity utility include a general electricity utility and a power producer and supplier that supply power to customers.

### [Control Information]

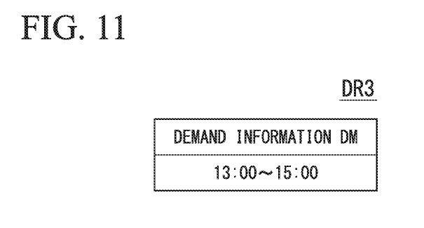

Hereinafter, the details of the control information DR3 of the present embodiment will be described with reference to FIG. 11. FIG. 11 schematically shows a table example of the control information DR3 of the second embodiment.

The control information DR3 includes demand information DM. The demand information DM is information regarding electric power generation and consumption predefined by the electricity utility PP. Specifically, the demand information DM is information indicating a time zone within which the power supply to the customers is to be reduced, as the power supplied by the power system decreases.

In a case where the demand information DM is applied, the controlled device CD operates with low power, such as in a power saving mode, in the time zone indicated by the demand information DM. In a case where the demand information DM is not applied, the controlled device CD operates in a normal mode even if the time zone is set to the demand information DM.

In this example, the demand information DM is information indicating the time zone from “13:00 to 15:00”.

### [Configuration of Device Control Manager]

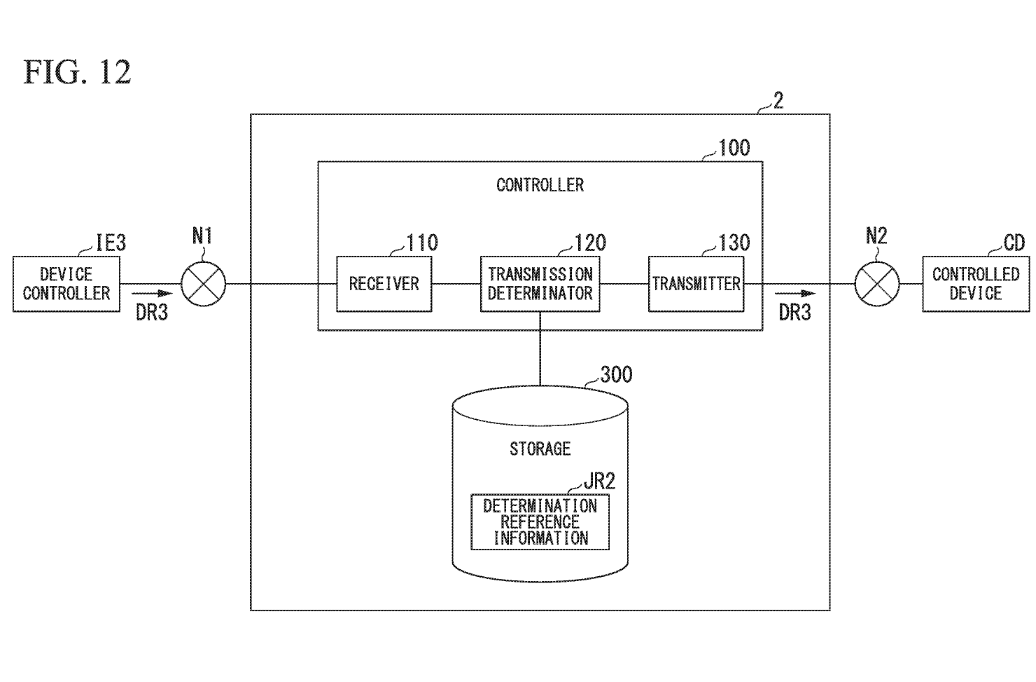

Hereinafter, a configuration of the device control manager 2 of the present embodiment will be described with reference to FIG. 12. FIG. 12 schematically illustrates a configuration example of the device control manager 2 of the second embodiment.

As shown in FIG. 12, the device control manager 2 and the device controller IE3 are connected via the network N1. The device controller IE3 transmits the control information DR3 to the device control manager 2 via the network N1.

### [Determination Reference Information]

The device control manager 2 includes the controller 100 and a storage 300.

The storage 300 previously stores determination reference information JR2. The determination reference information JR2 is reference information to be used for determining whether or not the control information DR3 received from the device controller IE3 is proper to be transmitted to the controlled device CD. Specifically, the determination reference information JR3 includes demand reference information MJR.

The demand reference information MJR includes a device identifier dID and demand applicability information ADM. The demand applicability information ADM is reference information regarding operations of the controlled devices CD based on the demand information DM. Specifically, the demand applicability information ADM is information indicating whether or not the demand information DM included in the control information DR3 is applied to the controlled device CD identified by the device identifier dID.

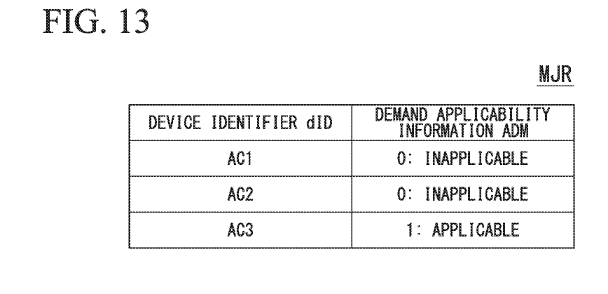

Hereinafter, the details of the demand reference information MJR will be described with reference to FIG. 13. FIG. 13 schematically shows a table example of the demand reference information MJR of the second embodiment.

In this example, the air conditioners AC identified by the device identifiers dID “AC1, AC2” are associated with the demand applicability information ADM (“0: inapplicable”) indicating that the demand information DM is not applied. Additionally, the air conditioner AC identified by the device identifier dID “AC3” is associated with the demand applicability information ADM (“1: applicable”) indicating that the demand information DM is applied.

Returning to FIG. 12, the receiver 110 receives the control information DR3 from the device controller IE3 via the network N1. The receiver 110 gives the received control information DR3 to the transmission determinator 120.

The transmission determinator 120 receives the control information DR3 from the receiver 110. Further, the transmission determinator 120 retrieves the determination reference information JR2 from the storage 300.

The transmission determinator 120 determines based on the determination reference information JR2 whether or not the demand information DM included in the control information DR3 is applied to the controlled device CD.

If the demand applicability information ADM in the demand reference information MJR indicates that the demand information DM is to be applied to the controlled device CD, the transmission determinator 120 determines that the control information DR3 is to be transmitted to the controlled device CD. If the demand applicability information ADM in the demand reference information MJR indicates that the demand information DM is not to be applied to the controlled device CD, the transmission determinator 120 determines that the control information DR3 is not to be transmitted to the controlled device CD.

In this example, the transmission determinator 120 determines that the control information DR3 is to be transmitted to the air conditioner AC identified by the device identifier dID “AC3”.

The transmitter 130 receives the control information DR3 from the transmission determinator 120. The transmitter 130 transmits the received control information DR3 to the controlled device CD via the network N2. The controlled device CD operates according to the control information DR3 transmitted from the device control manager 2.

Although the description has been given above with respect to the case where the device controller IE3 is connected to the device control manager 2 via the network N1, the present embodiment is not limited thereto. The device controller IE1 and the device controller IE3 may be connected to the device control manager 2 via the network N1.

Although the description has been given above with respect to the case where the storage 300 included in the device control manager 2 previously stores the determination reference information JR2, the present embodiment is not limited thereto. The storage 300 of the device control manager 2 may previously store the determination reference information JR1 and the determination reference information JR2.

In this case, the device control manager 2 may determine based on the determination reference information JR1 whether or not to transmit to the controlled device CD, the control information DR1 received from the device controller IE1. Additionally, the device control manager 2 may determine based on the determination reference information JR2 whether or not to transmit to the controlled device CD, the control information DR3 received from the device controller IE3.

Further, based on a result of the determination, the device control manager 2 may transmit the control information DR1 and the control information DR3 to the controlled device CD.

### Summary of Second Embodiment

As described above, in the device control manager 2 of the present embodiment, the receiver 110 receives the demand information DM regarding electric power generation and consumption by the electricity utility PP.

The determination reference information JR2 includes the demand reference information MJR which is reference information regarding the operations of the controlled devices CD based on the demand information DM.

The transmission determinator 120 determines based on the demand reference information MJR whether or not to transmit the control information DR3 to the controlled device CD.

Here, in a case where a demand response is applied to the operation of the controlled device CD so that the air conditioner AC as the controlled device CD operates with low power, such as in the power saving mode, it has been difficult to keep the temperature of the room installed with the air conditioner AC at a temperature suitable for the life of the occupant. Specifically, in a case where the air conditioner AC installed in a room used by an elderly person operates in the power saving mode according to the demand information DM, it has been difficult to keep the temperature of the room at a temperature suitable for the elderly person.

The device control manager 2 of the present embodiment determines based on the determination reference information JR2 whether or not to transmit the control information DR3 to the controlled device CD. The device control manager 2 determines whether or not the demand information DM included in the control information DR3 is to be applied to the controlled device CD. Then, the device control manager 2 transmits the control information DR3 to the controlled device CD to be applied with the demand information DM. Additionally, the device control manager 2 does not transmit the control information DR3 to the controlled device CD not to be applied with the demand information DM.

According to the device control manager 2 of the present embodiment, it is possible to prevent the operation of the controlled device CD not to be applied with the demand information DM included in the control information DR3 from being controlled by the control information DR3.

Therefore, the device control manager 2 of the present embodiment can prevent improper control information from being transmitted to the controlled device CD.

Although the description has been given above with respect to the case where the storage 200 previously stores the terminal reference information tJR, the present embodiment is not limited thereto.

For example, the device control manager 1 may determine whether or not to transmit the control information DR1, based on the terminal identifier tID of the device controller IE1 having a session key acquired from a certificate authority.

For example, in a case where a device controller IE1 controls the operation of the controlled device CD, the device controller IE1 may acquire, by a known method, the session key from the certificate authority. The device control manager 1 may authenticate, by a known method, the terminal identifier tID of the device controller IE1 having the session key and transmit to the controlled device CD, only control information DR1 transmitted from the authenticated device controller IE1.

Although the description has been given above with respect to the case where the storage 200 previously stores the application reference information aJR, the present embodiment is not limited thereto.

For example, the device control standard for the application and software used in controlling operations of the controlled devices CD may be evaluated by the certificate authority. In this case, the storage 200 may store the application identifier aID of the application and software meeting the device control standard provided by the certificate authority so that the application identifier aID can be updated sequentially.

Although the description has been given above with respect to the case where the storages 200 and 300 previously store the determination reference information JR1 and JR2, the present embodiment is not limited thereto. For example, the controller 100 may further include a generator (not shown) configured to generate the determination reference information JR1 and JR2, based on a plurality of control information previously received from the device controllers IE1 and IE3. Further, the generator of the controller 100 may be configured to update the generated determination reference information JR1 and JR2, based on control information newly received from the device controllers IE1 and IE3. Moreover, the storages 200 and 300 may be configured to store history information regarding the plurality of control information previously received from the device controllers IE1 and IE3, so that the generator of the controller 100 can refer to the history information to generate and update the determination reference information JR1 and JR2. Additionally, the processing example shown in the flowchart of FIG. 8 may include an additional step of generating and updating the determination reference information JR1 and JR2, in the above-described manner.

Here, each constituent element of the device control managers 1 and 2 may be realized by dedicated hardware, a microprocessor and memory, or the like.

Additionally, each constituent element of the device control managers 1 and 2 may include a CPU (central processing unit) and memory so that the functions of the respective elements of the device control managers 1 and 2 can be realized by the CPU loading onto the memory, and executing, a program for realizing the respective functions.

Further, a program for realizing the functions of the respective constituent elements of the device control managers 1 and 2 may be recorded in a computer readable recording medium so that the processing can be performed by a computer system reading and executing the program recorded in the computer readable recording medium. Here, the term “computer system” includes an OS, and hardware such as peripheral devices.

Moreover, the term “computer system” includes homepage providing environments (or display environments) as long as the WWW system is used.

Additionally, the term “computer-readable recording medium” refers to a portable medium, such as a flexible disk, a magneto-optical disk, a ROM, or a CD-ROM, or a storage device, such as a hard disk built in the computer system. Further, the term “computer-readable recording medium” may include: a medium which dynamically stores a program in a short period of time, such as a communication line when the program is transmitted via a network such as the Internet or via a communication line such as a telephone line; and a medium which stores the program in a fixed period of time, such as a volatile memory included in the computer system to be a server or a client in the above case. Moreover, the above-described program may be a program to implement some of the above-described functions or a program to implement the above-described functions in combination with the program already recorded in the computer system.

Additionally, each, some, or all of the respective constituent elements of the device control managers 1 and 2 may be realized typically as an LSI, which is an integrated circuit, or may be realized as a chipset. Each, some, or all of the functional elements may be integrated into a chip. The integration into a circuit is not limited to LSI and may be realized by a dedicated circuit or a general-purpose processor. When a technique for integration into a circuit, which will replace LSI, emerges with the advancement of semiconductor technology, an integrated circuit based on the advanced technique may be used.

The term “configured” is used to describe a component, section or part of a device which includes hardware and/or software that is constructed and/or programmed to carry out the desired function.

Although the embodiments of the present invention have been described above in detail with reference to the drawings, specific configurations are not limited to these embodiments, and any modification and combination of the embodiments may be made without departing from the scope of the present invention.

### Modified Examples

In addition, while not specifically claimed in the claim section, the application reserves the right to include in the claim section at any appropriate time, methods, devices, and systems according to the following examples and their equivalents.

### Example A

A1. A method for a first device, the method comprising:

generating first information indicating at least one of:
a clock time at which the first device transmits the first information,
a first value to be set to a first parameter of a second device to be controlled by the first device, and
a second value indicating a quantity of times the first device has transmitted the first information; and

transmitting the first information for a third device to determine whether or not to transfer the first information to the second device.

A2. A method for a first device, the method comprising:

receiving from a second device, first information indicating at least one of:
a clock time at which the second device has transmitted the first information,
a first value to be set to a first parameter of a third device to be controlled by the second device, and
a second value indicating a quantity of times the second device has transmitted the first information; and

transferring the first information to the third device in a case of determining based on the first information that the first information is to be transferred.

A3. A first device comprising:

generator circuitry configured and/or programmed to generate first information indicating at least one of:
a clock time at which the first device transmits the first information,
a first value to be set to a first parameter of a second device to be controlled by the first device, and
a second value indicating a quantity of times the first device has transmitted the first information; and

transmitter circuitry configured and/or programmed to transmit the first information for a third device to determine whether or not to transfer the first information to the second device.

A4. A first device comprising:

receiver circuitry configured and/or programmed to receive from a second device, first information indicating at least one of:
a clock time at which the second device transmits the first information,
a first value to be set to a first parameter of a third device to be controlled by the second device, and
a second value indicating a quantity of times the second device has transmitted the first information; and

transfer circuitry configured and/or programmed to transfer the first information to the third device in a case that it is determined based on the first information that the first information is to be transferred.

A5. A system comprising:

a first device;

a second device to be controlled by the first device; and

a third device, wherein

the first device comprises:

generator circuitry configured and/or programmed to generate first information indicating at least one of:
a clock time at which the first device transmits the first information,
a first value to be set to a first parameter of the second device, and
a second value indicating a quantity of times the first device has transmitted the first information; and

transmitter circuitry configured and/or programmed to transmit the first information for the third device to determine whether or not to transfer the first information to the second device.

### Example B

B1. A method for a first device, the method comprising:

generating first information indicating at least one of
a time zone within which a second device is authorized to control a third device,
a range in value within which the second device is authorized to control a first parameter of the third device, and
a maximum quantity of times the second device is authorized to transmit second information for controlling the third device; and

transferring the second information to the third device in a case of determining based on the first information and the second information that the second information is to be transferred.

B2. The method according to example B 1, further comprising:

receiving from the second device, the second information indicating at least one of:
a clock time at which the second device has transmitted the first information,
a first value to be set to a first parameter of the third device, and
a second value indicating a quantity of times the second device has transmitted the first information; and

determining that the second information is to be transferred, in a case that at least one of first to third conditions is met, wherein
the first condition is that the clock time is within the time zone,
the second condition is that the first value is within the range in value, and
the third condition is that the second value is equal to or less than the maximum quantity of times.
   B3. The method according to example B2, further comprising:

generating the first information based on a plurality of second information previously received from the second device; and

updating the first information based on the second information currently received and a result of the determining.

B4. A first device comprising:

generator circuitry configured and/or programmed to generate first information indicating at least one of
a time zone within which a second device is authorized to control a third device,
a range in value within which the second device is authorized to control a first parameter of the third device, and
a maximum quantity of times the second device is authorized to transmit second information for controlling the third device; and

transfer circuitry configured and/or programmed to transfer the second information to the third device in a case of determining based on the first information and the second information that the second information is to be transferred.

B5. The first device according to example B4, further comprising:

receiver circuitry configured and/or programmed to receive from the second device, the second information indicating at least one of:
a clock time at which the second device has transmitted the first information,
a first value to be set to a first parameter of the third device, and
a second value indicating a quantity of times the second device has transmitted the first information; and

determinator circuitry configured and/or programmed to determine that the second information is to be transferred, in a case that at least one of first to third conditions is met, wherein
the first condition is that the clock time is within the time zone,
the second condition is that the first value is within the range in value, and
the third condition is that the second value is equal to or less than the maximum quantity of times.
   B6. The first device according to example B5, wherein

the generator circuitry is configured and/or programmed to
generate the first information based on a plurality of second information previously received from the second device, and
update the first information based on the second information currently received and a result of the determining.
   B7. A system comprising:

a first device;

a second device; and

a third device to be controlled by the second device, wherein

the first device comprises:

generator circuitry configured and/or programmed to generate first information indicating at least one of
a time zone within which the second device is authorized to control the third device,
a range in value within which the second device is authorized to control a first parameter of the third device, and
a maximum quantity of times the second device is authorized to transmit second information for controlling the third device; and

transfer circuitry configured and/or programmed to transfer the second information to the third device in a case of determining based on the first information and the second information that the second information is to be transferred.

B8. The system according to example B7, wherein

the first device further comprises:

receiver circuitry configured and/or programmed to receive from the second device, the second information indicating at least one of:
a clock time at which the second device has transmitted the first information,
a first value to be set to a first parameter of the third device, and
a second value indicating a quantity of times the second device has transmitted the first information; and

determinator circuitry configured and/or programmed to determine that the second information is to be transferred, in a case that at least one of first to third conditions is met, wherein
the first condition is that the clock time is within the time zone,
the second condition is that the first value is within the range in value, and
the third condition is that the second value is equal to or less than the maximum quantity of times.
   B9. The system according to example B8, wherein

the generator circuitry configured and/or programmed to
generate the first information based on a plurality of second information previously received from the second device, and
update the first information based on the second information currently received and a result of the determining.

### Example C

C1. A method for a first device, the method comprising:

receiving from a second device, first information for controlling a third device; and

transferring the first information to the third device in a case of determining based on the first information that at least one of first to third conditions is met, wherein

the first condition is that a clock time at which the second device has transmitted the first information is within an authorized time zone,

the second condition is that a first value to be set to a first parameter of the third device is within an authorized range in value, and

the third condition is that a quantity of times the second device has transmitted the first information is equal to or less than an authorized maximum quantity of times.

C2. The method according to example C1, wherein

the first information indicates at least one of the clock time, the first value (ST), and the quantity of times.

C3. The method according to example C1, further comprising:

generating based on a plurality of first information previously received from the second device, second information indicating at least one of the authorized time zone, the authorized range in value, and the authorized maximum quantity of times;

determining based on the first information currently received and the second information whether or not at least one of the first to third conditions is met; and

updating the second information based on the first information currently received and a result of the determining.

C4. A first device comprising:

receiver circuitry configured and/or programmed to receive from a second device, first information for controlling a third device; and

transfer circuitry configured and/or programmed to transfer the first information to the third device in a case of determining based on the first information that at least one of first to third conditions is met, wherein

the first condition is that a clock time at which the second device has transmitted the first information is within an authorized time zone,

the second condition is that a first value to be set to a first parameter of the third device is within an authorized range in value, and

the third condition is that a quantity of times the second device has transmitted the first information is equal to or less than an authorized maximum quantity of times.

C5. The first device according to example C4, wherein

the first information indicates at least one of the clock time, the first value, and the quantity of times.

C6. The first device according to example C4, further comprising:

generator circuitry configured and/or programmed to generate based on a plurality of first information previously received from the second device, second information indicating at least one of the authorized time zone, the authorized range in value, and the authorized maximum quantity of times; and

determinator circuitry configured and/or programmed to determine based on the first information currently received and the second information whether or not at least one of the first to third conditions is met, wherein

the generator circuitry is configured and/or programmed to update the second information based on the first information currently received and a result of the determining.

C7. A system comprising:

a first device;

a second device; and

a third device to be controlled by the second device, wherein

the first device comprises:

receiver circuitry configured and/or programmed to receive from the second device, first information for controlling the third device; and

transfer circuitry configured and/or programmed to transfer the first information to the third device in a case of determining based on the first information that at least one of first to third conditions is met, wherein

the first condition is that a clock time at which the second device has transmitted the first information is within an authorized time zone,

the second condition is that a first value to be set to a first parameter of the third device is within an authorized range in value, and

the third condition is that a quantity of times the second device has transmitted the first information is equal to or less than an authorized maximum quantity of times.

C8. The system device according to example C7, wherein

the first information indicates at least one of the clock time, the first value, and the quantity of times.

C9. The system according to example C7, wherein

the first device further comprises:

generator circuitry configured and/or programmed to generate based on a plurality of first information previously received from the second device, second information indicating at least one of the authorized time zone, the authorized range in value, and the authorized maximum quantity of times; and

determinator circuitry configured and/or programmed to determine based on the first information currently received and the second information whether or not at least one of the first to third conditions is met, wherein

the generator circuitry is configured and/or programmed to update the second information based on the first information currently received and a result of the determining.

### Example D

D1. A method for a first device, the method comprising:

receiving from a second device, first information for controlling a third device;

determining based on the first information whether or not at least one of first to third conditions is met, wherein
the first condition is that a clock time at which the second device has transmitted the first information is within an authorized time zone,
the second condition is that a first value to be set to a first parameter of the third device is within an authorized range in value, and
the third condition is that a quantity of times the second device has transmitted the first information is equal to or less than an authorized maximum quantity of times; and

transferring the first information to the third device in the case of determining that at least one of the first to third conditions is met.

D2. The method according to example D1, wherein

the first information indicates at least one of the clock time, the first value, and the quantity of times.

D3. The method according to example D1, further comprising:

generating based on a plurality of first information previously received from the second device, second information indicating at least one of the authorized time zone, the authorized range in value, and the authorized maximum quantity of times;

determining based on the first information currently received and the second information whether or not at least one of the first to third conditions is met; and

updating the second information based on the first information currently received and a result of the determining.

D4. A first device comprising:

receiver circuitry configured and/or programmed to receive from a second device, first information for controlling a third device;

determinator circuitry configured and/or programmed to determine based on the first information whether or not at least one of first to third conditions is met, wherein
the first condition is that a clock time at which the second device has transmitted the first information is within an authorized time zone,
the second condition is that a first value to be set to a first parameter of the third device is within an authorized range in value, and
the third condition is that a quantity of times the second device has transmitted the first information is equal to or less than an authorized maximum quantity of times; and

transfer circuitry configured and/or programmed to transfer the first information to the third device in the case of determining that at least one of the first to third conditions is met.

D5. The first device according to example D4, wherein

the first information indicates at least one of the clock time, the first value, and the quantity of times.

D6. The first device according to example D4, further comprising:

generator circuitry configured and/or programmed to generate based on a plurality of first information previously received from the second device, second information indicating at least one of the authorized time zone, the authorized range in value, and the authorized maximum quantity of times; and

determinator circuitry configured and/or programmed to determine based on the first information currently received and the second information whether or not at least one of the first to third conditions is met, wherein

the generator circuitry is configured and/or programmed to update the second information based on the first information currently received and a result of the determining.

D7. A system comprising:

a first device;

a second device; and

a third device to be controlled by the second device, wherein

the first device comprises:

receiver circuitry configured and/or programmed to receive from a second device, first information for controlling a third device;

determinator circuitry configured and/or programmed to determine based on the first information whether or not at least one of first to third conditions is met, wherein
the first condition is that a clock time at which the second device has transmitted the first information is within an authorized time zone,
the second condition is that a first value to be set to a first parameter of the third device is within an authorized range in value, and
the third condition is that a quantity of times the second device has transmitted the first information is equal to or less than an authorized maximum quantity of times; and

transfer circuitry configured and/or programmed to transfer the first information to the third device in the case of determining that at least one of the first to third conditions is met.

D8. The system according to example D7, wherein

the first information indicates at least one of the clock time, the first value, and the quantity of times.

D9. The system according to example D7, wherein

the first device further comprises:

generator circuitry configured and/or programmed to generate based on a plurality of first information previously received from the second device, second information indicating at least one of the authorized time zone, the authorized range in value, and the authorized maximum quantity of times; and

determinator circuitry configured and/or programmed to determine based on the first information currently received and the second information whether or not at least one of the first to third conditions is met, wherein

the generator circuitry is configured and/or programmed to update the second information based on the first information currently received and a result of the determining.

What is claimed is:

1. A first device comprising:
receiver circuitry configured and/or programmed to receive from a second device, first information for controlling a third device;
determinator circuitry configured and/or programmed to determine whether or not the first information is to be transmitted to the third device, based on the first information received and second information stored in the first device, the second information regarding at least a first parameter of the third device that the second device is authorized to control; and
transmitter circuitry configured and/or programmed to, in a case that the first information is determined to be transmitted to the third device, transmit the first information to the third device.

2. The first device according to claim 1, wherein
the first information indicates at least
a first value that the second device requests the third device to set to the first parameter,
a clock time at which the second device has currently transmitted the first information, and
a quantity of times the second device has already transmitted the first information,
the second information indicates at least
a range in value within which the second device is authorized to control the first parameter of the third device,
a time zone within which the second device is authorized to control the third device, and
a maximum quantity of times the second device is authorized to transmit the first information, and
the determinator circuitry is configured and/or programmed to determine that the first information is to be transmitted to the third device, in a case that at least one of first to third conditions is met, wherein
the first condition is that the first value is within the range in value,
the second condition is that the clock time is within the time zone, and
the third condition is that the quantity of times is less than the maximum quantity of times.

3. The first device according to claim 1, wherein
the receiver circuitry is configured and/or programmed to receive from a fourth device, third information for controlling the third device, the third information regarding a demand on power generation and consumption predefined by the fourth device, the second information further indicates a fifth device to be subject to the demand,
the determinator circuitry is configured and/or programmed to determine that the third information is to be transmitted to the third device, in a case that the third device is the fifth device, and
the transmitter circuitry is configured and/or programmed to, in a case that the third information is determined to be transmitted to the third device, transmit the third information to the third device.

4. A method for a first device, the method comprising:
receiving from a second device, first information for controlling a third device;
determining whether or not the first information is to be transmitted to the third device, based on the first information received and second information stored in the first device, the second information regarding at least a first parameter of the third device that the second device is authorized to control; and
in a case that the first information is determined to be transmitted to the third device, transmitting the first information to the third device.

5. The method according to claim 4, wherein
the first information indicates at least
a first value that the second device requests the third device to set to the first parameter,
a clock time at which the second device has currently transmitted the first information, and
a quantity of times the second device has already transmitted the first information,
the second information indicates at least
a range in value within which the second device is authorized to control the first parameter of the third device,
a time zone within which the second device is authorized to control the third device, and
a maximum quantity of times the second device is authorized to transmit the first information, and
determining that the first information is to be transmitted to the third device, in a case that at least one of first to third conditions is met, wherein
the first condition is that the first value is within the range in value,
the second condition is that the clock time is within the time zone, and
the third condition is that the quantity of times is less than the maximum quantity of times.

6. The method according to claim 4, further comprising:
receiving from a fourth device, third information for controlling the third device, the third information regarding a demand on power generation and consumption predefined by the fourth device, wherein the second information further indicates a fifth device to be subject to the demand;
determining that the third information is to be transmitted to the third device, in a case that the third device is the fifth device; and
in a case that the third information is determined to be transmitted to the third device, transmitting the third information to the third device.

7. A system comprising:
a first device;
a second device to be controlled by the first device; and
a third device configured to communicate with the first device and the second device, wherein
the third device comprises:
receiver circuitry configured and/or programmed to receive from the first device, first information for controlling the second device;
determinator circuitry configured and/or programmed to determine whether or not the first information is to be transmitted to the second device, based on the first information received and second information stored in the third device, the second information regarding at least a first parameter of the second device that the first device is authorized to control; and
transmitter circuitry configured and/or programmed to, in a case that the first information is determined to be transmitted to the second device, transmit the first information to the second device.

8. The system according to claim 7, wherein
the first information indicates at least
a first value that the first device requests the second device to set to the first parameter,
a clock time at which the first device has currently transmitted the first information, and
a quantity of times the first device has already transmitted the first information,
the second information indicates at least
a range in value within which the first device is authorized to control the first parameter of the second device,
a time zone within which the second device is authorized to control the third device, and
a maximum quantity of times the first device is authorized to transmit the first information, and
the determinator circuitry is configured and/or programmed to determine that the first information is to be transmitted to the third device, in a case that at least one of first to third conditions is met, wherein
the first condition is that the first value is within the range in value,
the second condition is that the clock time is within the time zone, and
the third condition is that the quantity of times is less than the maximum quantity of times.

9. The system according to claim 7, further comprising:
a fourth device, wherein
the receiver circuitry is configured and/or programmed to receive from the fourth device, third information for controlling the second device, the third information regarding a demand on power generation and consumption predefined by the fourth device,
the second information further includes a fifth device to be subject to the demand,
the determinator circuitry is configured and/or programmed to determine that the third information is to be transmitted to the third device, in a case that the second device is the fifth device, and
the transmitter circuitry is configured and/or programmed to, in a case that the third information is determined to be transmitted to the second device, transmit the third information to the second device.
